(19) United States
(12) Patent Application Publication
(10) Pub. No.: US 2008/0008114 A1
(43) Pub. Date: Jan. 10, 2008

(54) UPnP device control protocol for mobile telephones

(75) Inventors: Kari Kaarela, Oulu (FI); Kirmo Koistinen, Oulu (FI); Timo Tervo, Oulu (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/408,720

(22) Filed: Apr. 21, 2006

(51) Int. Cl. H04Q 7/00

(52) U.S. Cl. 370/328

(57) ABSTRACT

A UPnP device control protocol for mobile telephones. The device control protocol of the present invention defines the services, actions, and state variables that a UPnP mobile device would expose to a UPnP network. According to the present invention, a mobile telephone or device would act primarily as a UPnP device, offering its services to other devices, such as televisions. These services may include messaging, telephone calls, telephone book functions, calendar functions, and other functions.

### FIELD OF THE INVENTION

The present invention relates generally to the Universal Plug and Play (UPnP) device architecture. More particularly, the present invention relates to UPnP device control protocols (DCP's).

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Universal Plug and Play (UPnP) technology defines an architecture for pervasive peer-to-peer network connectivity of intelligent appliances, wireless devices, and personal computers of all form factors. UPnP is designed to bring easy-to-use, flexible, standards-based connectivity to ad-hoc or unmanaged networks whether in the home, in a small business, public spaces, or attached to the Internet. UPnP technology provides a distributed, open networking architecture that leverages TCP/IP and the Web technologies to enable seamless proximity networking, in addition to control and data transfer among networked devices.

The UPnP Device Architecture (UDA) is designed to support zero-configuration, “invisible” networking and automatic discovery for a breadth of device categories from a wide range of vendors. In other words, the UDA enables a device to dynamically join a network, obtain an IP address, convey its capabilities, and learn about the presence and capabilities of other devices.

The UPnP architecture comprises two layers: a general purpose UDA and device-specific device control protocols (DCP). This structure is depicted in FIG. 1. The UPnP protocol stack is depicted in FIG. 2. There are currently about ten standardized DCPs for various device categories. However, there is currently no UPnP device control protocol available for mobile telephones. This fact limits the ability to utilize UPnP technology for various kinds of services that a mobile telephone could offer for other devices (including other mobile telephones). Attempts have been made to implement the same types of functionality as would be implemented by a mobile telephone-specific DCP. For example, one approach involves having an external device obtain access to some of the mobile telephone's services via a standard web browser. The telephone runs a simple web server that provides the user interface (UI) and the interface to the service logic.

### SUMMARY OF THE INVENTION

The present invention comprises a UPnP device control protocol for mobile telephones. The device control protocol of the present invention defines the services, actions, and state variables that a UPnP mobile device would expose to a UPnP network. According to the present invention, a mobile telephone or device would act primarily as a UPnP device, offering its services to other devices, such as televisions. These services may include messaging (e.g., transmitting SMS, MMS, and email messages), telephone calls (e.g., placing telephone calls from a television), telephone book functions, calendar functions, and others.

The UPnP device control protocol for mobile devices of the present invention is applicable to a wide variety of potential use cases. The device control protocol adds value to end users, particularly when in the digital home. The present invention also enables the development of several new and exciting features and new product opportunities for manufacturers. The present invention can be implemented in virtually any mobile telephone that has UPnP support. The present invention also provides benefits to non-mobile telephone vendors, such as television manufacturers, due to the added functionality made possible through the present invention.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a representation of the UPnP standards structure, showing how the UPnP is built from the UDA and the device control protocols specified for various device categories;

FIG. 2 is a representation of the UPnP protocol stack;

FIG. 3 is a representation of a mobile telephone control point, a media server in the form of a personal computer, and a media renderer in the form of a television, in communication with each other so that the mobile telephone's user interface may be used to exhibit media from a personal computer onto the television;

FIG. 4 is a depiction showing how the control point, the media server, and the media renderer of FIG. 3 interact to exhibit media on the television;

FIG. 5 is a representation showing how the mobile telephone UPnP device components of the present invention are related to various other UPnP and smart phone platform entities;

FIG. 6 is a perspective view of a mobile telephone that can be used in the implementation of the present invention; and

FIG. 7 is a schematic representation of the telephone circuitry of the mobile telephone of FIG. 6.

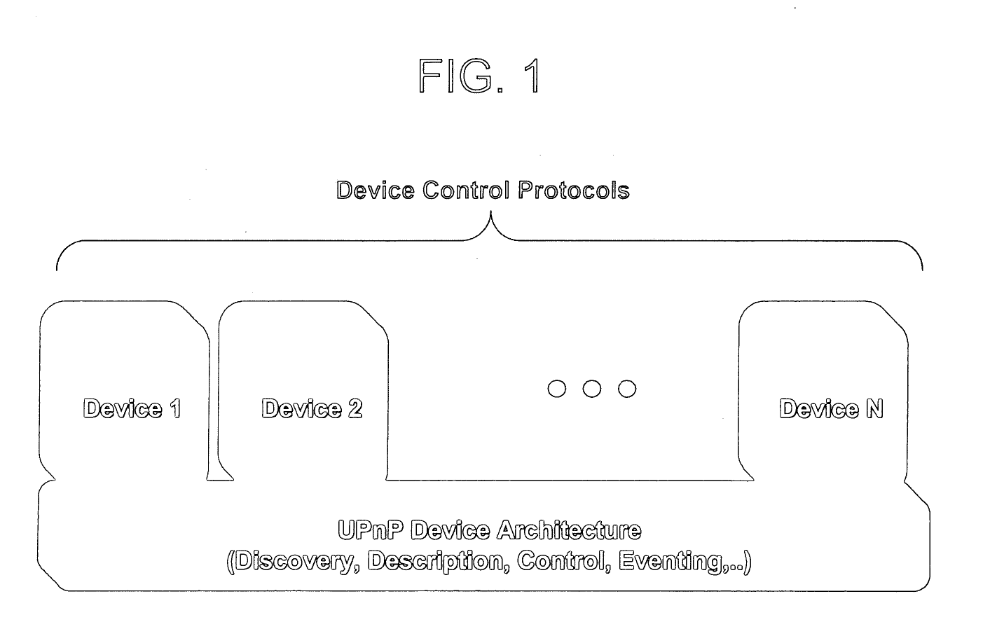

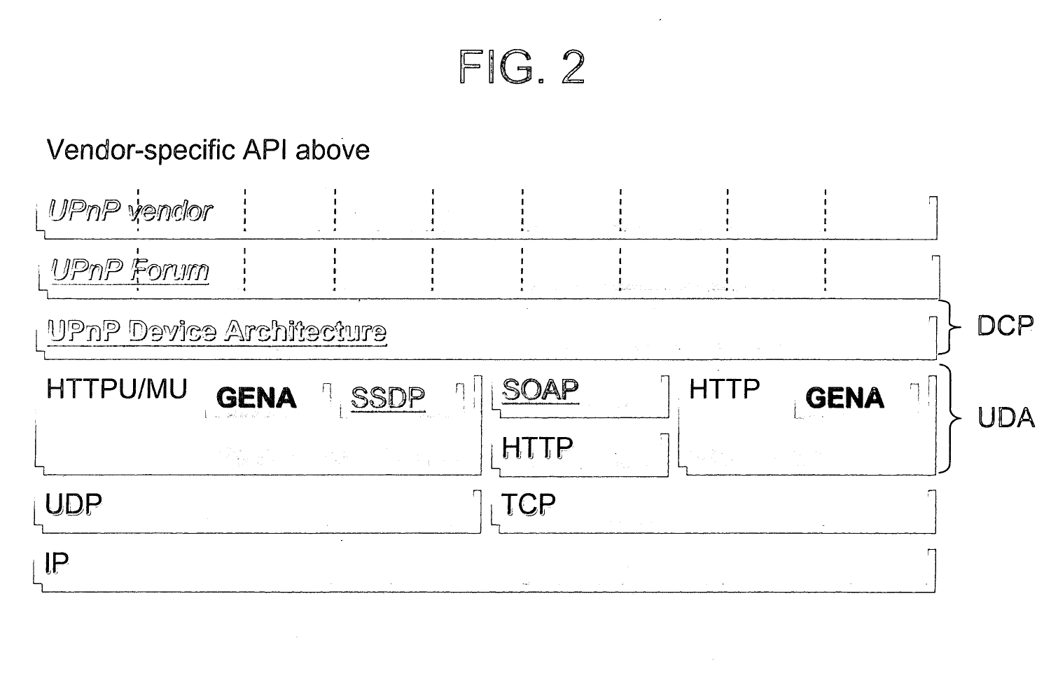

### DETAILED DESCRIPTION OF THE PREFERRED EMBODIMENTS

The present invention comprises a UPnP device control protocol for mobile telephones. The device control protocol of the present invention defines the services, actions, and state variables that a UPnP mobile device would expose to a UPnP network.

As discussed herein, a UPnP device is a passive entity that waits to be used. Each UPnP device contains zero or more services, and each device optionally contains a deck of HTML pages for user interaction. A UPnP service implements a standard device control protocol. UPnP services advertise their presence on the network and make available control and eventing URL's. UPnP control points search for and use services exposed by UPnP devices. UPnP control points are not discoverable network entities, and there are no control point standards. UPnP control points can implement applications with a user interface, library, bot, web pages, etc., so long as it calls the service in the correct way. It is important to note that a UPnP control point and a UPnP device can be in the same device.

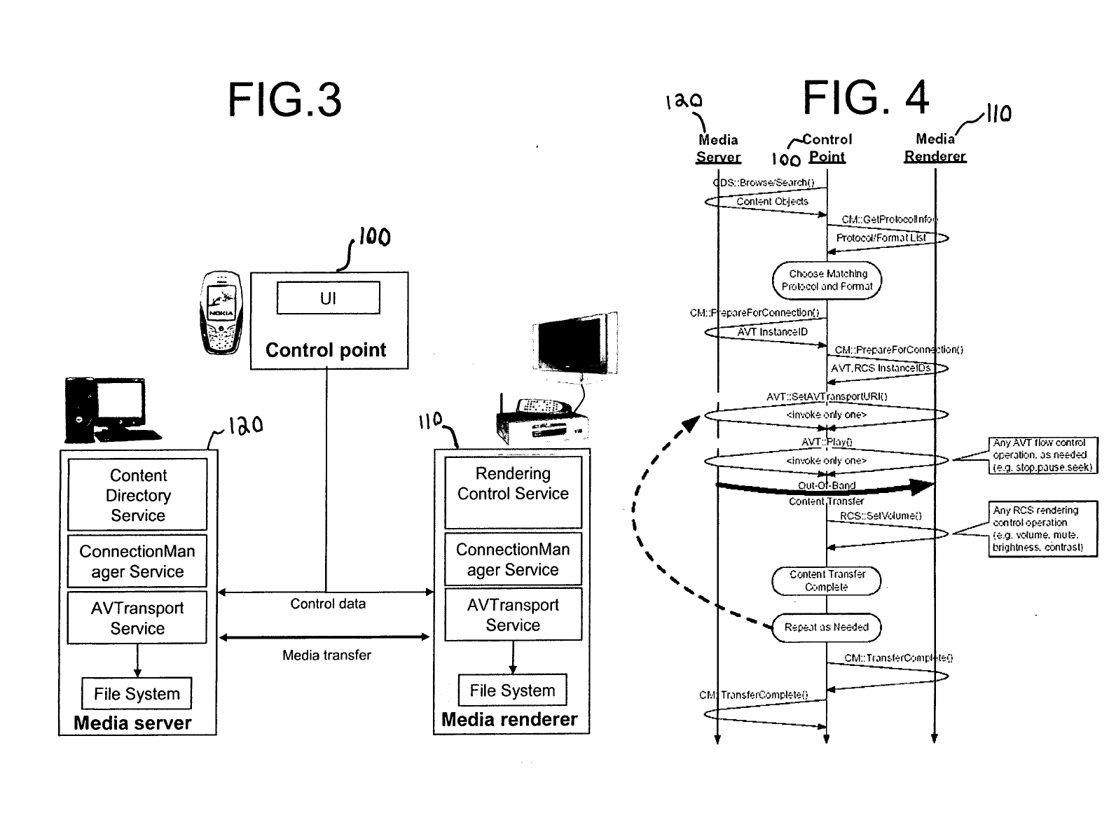

FIGS. 3 and 4 show how a mobile telephone control point 100, a media renderer 110 and a media server 120 interact so that the user interface of the mobile telephone control point 100 can be used to display images from the media server 120 onto the media renderer 110. In this particular example, the media server 120 comprises a personal computer, while the media renderer 110 comprises a television. As shown in FIGS. 3 and 4, media is transferred directly between the media renderer 110 and the media server 120 as a result of control data which passes among the mobile telephone control point 100, the media renderer 110 and the media server 120. FIG. 4 shows the steps of this process in detail.

According to the present invention, a mobile telephone or device can act primarily as a UPnP device, offering its services to other devices, such as televisions. These services may include messaging (e.g., transmitting SMS, MMS, and email messages), telephone calls (e.g., placing telephone calls from a television), telephone book functions, calendar functions, and others. In addition, a mobile telephone based on the device control protocols of the present invention can also act as a UPnP control point, capable of using the services offered by other mobile telephones (e.g., phonebook programs).

The implementation of the invention follows the generic principles of UPnP and includes a number of primary components. A first component is the UPnP stack. All of the devices in the UPnP network must implement the UPnP stack (UDA). The UPnP stack is required in the UPnP devices and the UPnP control points. A second component is a UPnP mobile telephone device. The UPnP mobile telephone device is a UPnP device with the service of the mobile telephone that one wants to expose, as well as the respective actions and state variables. These are implemented in the mobile telephone. The third component is the UPnP mobile telephone control point. The UPnP mobile telephone control point is a UPnP control point that is able to discover UPnP mobile telephone devices and use its services. In other words, this UPnP control point has the user interface and application logic to use the UPnP mobile telephone's services. This is implemented primarily in external devices. However, it could also be implemented in the mobile telephone to allow, for example, usage of other telephones' calendars, telephone books, etc.

The following are examples of various use case situations involving the device control protocol of the present invention. It should be noted, however, that other use cases are also possible, and the present invention should not be interpreted as being limited to the examples contained herein.

A first set of use case scenarios involves interactions between a personal computer (PC) and a mobile telephone. In these use cases, it is possible to drastically improve the PC suite-type of user experience. For example, a personal information manager (PIM) data can be synchronized, for example by using SyncML as an out-of-band protocol. Calendars, telephone books, galleries, and other items that are stored on the mobile telephone can be viewed on the PC and vice versa. This arrangement also allows for messaging to be conducted through the telephone when they otherwise could have to be conducted through the PC. Network and/or telephone services of one device can be used on the other device, and there is no need to start any specific application (such as a PC suite application.) Instead, the services of one device can simply and immediately appear in the user interface of the other device when the mobile telephone comes within the necessary range.

Another set of use case scenarios involve the interaction of a mobile telephone and consumer electronics, such as televisions and home stereos. In this situation, the services of a mobile telephone, such as calendars, telephone books, etc., can be accessed using a television. Additionally telephone calls can be made through the mobile telephone using the television and/or home stereo. VoIP calls may also be implemented in various embodiments. Additionally, images and other multimedia items can be synchronized from the mobile telephone to a media server.

A third set of use scenarios involve the interaction between two mobile telephones. In this situation, both “DCP server” and control point implementation are required. With the present invention, one can synchronize content between telephones, enable multidevice ownership (MDO), and move/copy content between devices.

In one embodiment of the invention, UPnP security is used in conjunction with device control protocol for mobile telephones. Given the fact that a wide variety of confidential data is often stored on the mobile telephones, this information can potentially be accessed without authorization. Additionally, there also exists the potential for telephone services such as messages, networking, and calls, to be used without authorization. Therefore, UPnP security can be made mandatory with this particular device protocol. Other security solutions may also be implemented.

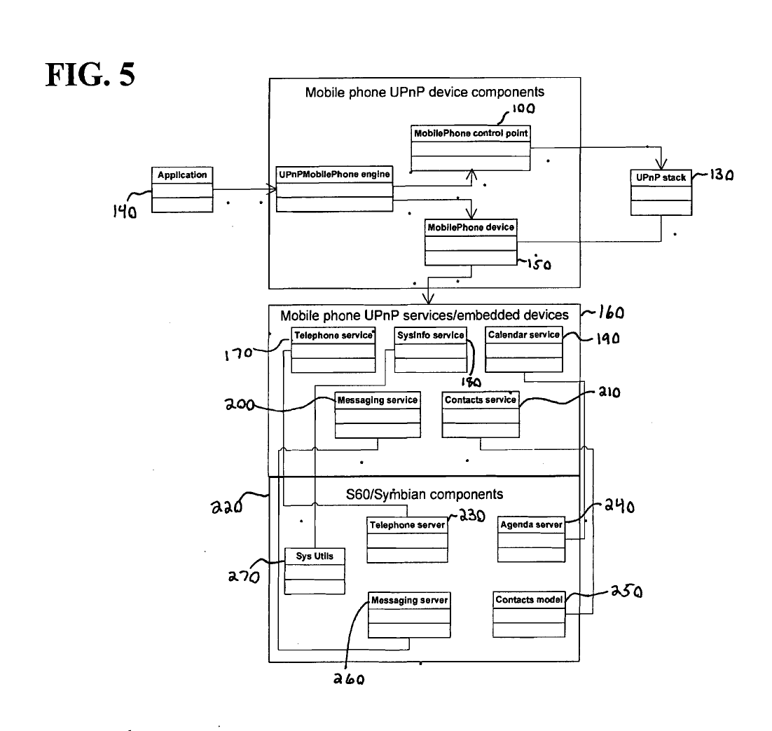

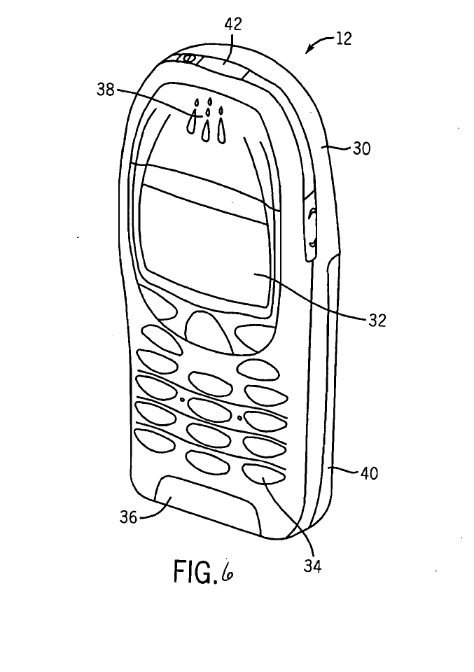

FIG. 5 shows how the mobile telephone UPnP device components of the present invention are related to various other UPnP and smart phone platform entities. As shown in FIG. 5, the mobile telephone control point 100 interacts with the UPnP stack 130 and a UPnP mobile telephone engine 135, which interacts with one or more applications 140. The UPnP mobile telephone engine 135 and the UPnP stack 130 are also communicatively associated with a mobile telephone device 150. The mobile telephone device 150 interacts with a plurality of mobile telephone UPnP services/embedded devices 160. These items include telephone services 170, system information services 180, calendar services 190, messaging services 200, and contacts services 210. The various mobile telephone UPnP services/embedded devices 160 also interact with a plurality of S60/Symbian components 220. These components include a telephone server 230, an agenda server 240, a contacts model 250, a messaging server 260, and system utilities 270.

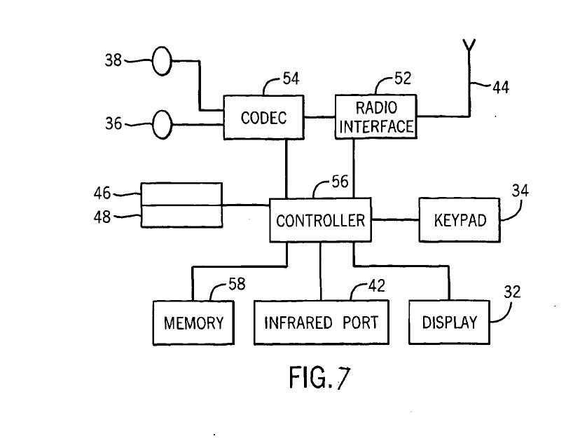

FIGS. 6 and 7 show one representative mobile telephone 12 within which the present invention may be implemented. It should be understood, however, that the present invention is not intended to be limited to one particular type of mobile telephone 12 or other electronic device. The mobile telephone 12 of FIGS. 6 and 7 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The present invention is described in the general context of method steps, which may be implemented in one embodiment by a program product including computer-executable instructions, such as program code, executed by computers in networked environments.

Communication devices described herein may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule-based logic and other logic to accomplish the various database searching steps, correlation steps, comparison steps and decision steps. It should also be noted that the words “component” and “module” as used herein, and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A UPnP system for providing services, comprising:
a UPnP mobile telephone device possessing a service capable of being made available within the UPnP system; and
a UPnP mobile telephone control point in communication range of the UPnP mobile telephone device, the UPnP mobile telephone control point configured to discover the UPnP mobile telephone device and to access the service;
wherein the UPnP mobile telephone device and the UPnP mobile telephone control point each are configured to implement a UPnP stack including a mobile telephone device control protocol.

2. The UPnP system of claim 1, wherein the UPnP mobile telephone control point is configured to render the service on a rendering device.

3. The UPnP system of claim 2, wherein the rendering device comprises the UPnP mobile telephone control point.

4. The UPnP system of claim 2, wherein the rendering device comprises a device separate from the UPnP mobile telephone control point.

5. The UPnP system of claim 2, wherein the rendering device comprises a television.

6. The UPnP system of claim 2, wherein the rendering device comprises a different UPnP mobile telephone device.

7. The UPnP system of claim 2, wherein the rendering device comprises a different UPnP mobile telephone device.

8. The UPnP system of claim 2, wherein the service comprises a telephone service.

9. The UPnP system of claim 2, wherein the service comprises a VoIP service.

10. The UPnP system of claim 2, wherein the service comprises at least one of the group of services consisting of phonebook services, calendar services, media gallery services and synchronization services.

11. A UPnP mobile telephone control point, comprising:
a processor; and
a memory unit operatively connected to the processor and including:
computer code for discovering and enabling communication with a UPnP mobile telephone device,
computer code for accessing a service located on the UPnP mobile telephone device,
computer code for rendering the service on a rendering device,
wherein the UPnP mobile telephone control point is configured to implement a UPnP stack including a mobile telephone device control protocol.

12. The UPnP mobile telephone control point of claim 11, wherein the rendering device comprises the UPnP mobile telephone control point.

13. The UPnP mobile telephone control point of claim 11, wherein the rendering device comprises a device separate from the UPnP mobile telephone control point.

14. The UPnP mobile telephone control point of claim 11, wherein the rendering device comprises a television.

15. The UPnP mobile telephone control point of claim 11, wherein the service comprises a telephone service.

16. The UPnP mobile telephone control point of claim 11, wherein the service comprises a VoIP service.

17. The UPnP mobile telephone control point of claim 11, wherein the service comprises at least one of the group of services consisting of phonebook services, calendar services, media gallery services and synchronization services.

18. A computer program product for rendering content from a UPnP mobile telephone device on a rendering device, comprising:
computer code for discovering and enabling communication with the UPnP mobile telephone device;
computer code for accessing a service located on the UPnP mobile telephone device;
computer code for rendering the service on the rendering device;
wherein the UPnP mobile telephone control point is configured to implement a UPnP stack including a mobile telephone device control protocol.

19. The computer program product of claim 18, wherein the rendering device comprises the UPnP mobile telephone control point.

20. The computer program product of claim 18, wherein the rendering device comprises a device separate from the UPnP mobile telephone control point.

21. The computer program product of claim 18, wherein the service comprises a telephone service.

22. The computer program product of claim 18, wherein the service comprises at least one of the group of services consisting of phonebook services, calendar services, media gallery services and synchronization services.

23. A method of providing content among devices within a UPnP network, comprising:
using a UPnP mobile telephone control point to discover and enable communication with a UPnP mobile telephone device; and
using the UPnP mobile telephone control point to access a service located on the UPnP mobile telephone device; and
using the UPnP mobile telephone control point to render the service on a rendering device,
wherein the UPnP mobile telephone device and the UPnP mobile telephone control point each are configured to implement a UPnP stack including a mobile telephone device control protocol.

24. The method of claim 23, wherein the rendering device comprises the UPnP mobile telephone control point.

25. The method of claim 23, wherein the rendering device comprises a device separate from the UPnP mobile telephone control point.

26. The method of claim 23, wherein the rendering device comprises a television.

27. The method of claim 23, wherein the service comprises a telephone service.

28. The method of claim 23, wherein the service comprises at least one of the group of services consisting of phonebook services, calendar services, media gallery services and synchronization services.

29. The method of claim 23, wherein the service comprises a VoIP service.
